(19) United States
(12) Patent Application Publication
(10) Pub. No.: US 2005/0089355 A1
(43) Pub. Date: Apr. 28, 2005

(54) System of two-panel keyboard

(76) Inventor: Anuthep Benja-Athon, New York, NY (US)

Correspondence Address: ANUTHEP BENJA-ATHON, M.D.;Pain Management, Acupuncture Physical Therapy, 210 E 36th St., New York, NY, 10016, US

(21) Appl. No.: 10/693,715

(22) Filed: Oct. 27, 2003

(51) Int. Cl. B41J 5/08

(52) U.S. Cl. 400/472

(57) ABSTRACT

A system of two separate panels of computer keyboard for reducing the motions and promoting the ergonomic posture of the shoulders and upper arms of a computer-keyboard user. A first independent keyboard panel comprises all keys bearing all numerics, alphabets, words, symbols, signs and functions to the left of and including keys 5, T, G, B. A second independent keyboard panel comprises all keys bearing all numerics, alphabets, words, symbols, signs and functions to the right of and including keys 6, Y, H, N. A camera and a support base comprises a mold for the hand-wrist-forearm and various types of sensors are incorporated into the panel to minimize the unnecessary movements and effect the ergonomic posture of the limb and shoulder.

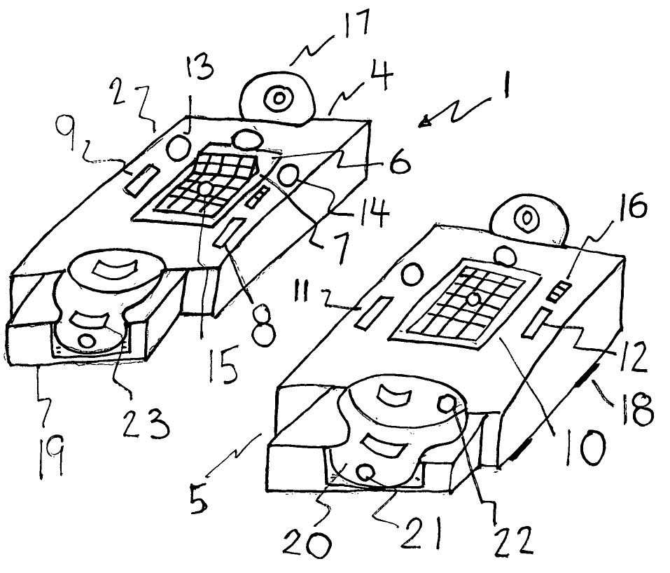

### FIELD OF INVENTION

A system of two computer-keyboard panels for reducing injuries to shoulders and arms.

### BACKGROUND OF THE INVENTION

The designs and applications of typewritter and computer keyboards of prior art do not account for the ergonomics of the upper extremity based on the anatomy, physiology and biomechanics of the shoulders and upper arms as they relate to a computer, laptop and hand-held computers, cash registers and the like henceforth devices and the workstations. The anatomy, physiology and biomechanics of the shoulders and upper arms heretofore had neither been taken into account, known nor understood by the designers and manufacturers of keyboards of prior art. Essentially, the contemporary keyboards being widely used today with computers are vintage typewritter keyboards plus other accesories listed infra.

The modern-day keyboards as relate to the devices enhance the productivity of a computer user who spent long hours each day manuvering the structures of the shoulders and upper extremities that are spatially positioned to the left and right of both ends of a computer keyboard. Therefore, the shoulders and upper arms must move such as, but not limited to, internal and external rotate, abduct and adduct in order to use and operate the a keyboard and all other accessories such as computer mouse, dials, scrolling and pointing devices that are clustered on said keyboard placed before the computer user's torso and also scattered to the sides of said user's left and right shoulders and upper arms. Moreover, the shoulders and arms are in poor postures due to the designs and placements of said equipments.

Consequently, harmful movements and poor postures of the shoulders and upper arms using said equipments of prior art resulted in the stress, strain, sprain and injuries of the structural components of the shoulders and upper arms. Said injuries are irreversible, chronic and disabiling for most computer users. These prevalent disorders and injuries of the were observed by this physician applicant. Heretofore, there was no understanding and solution were had. Billions of dollars are spent annually for the so-called ergonomics consultants, worker trainings, equipment and workstations redesign, insurance premiums and compensations. The costs escalate as the reliance on computers continues to increase. However, the cost-effectiveness of these expenses cannot be realized as it was made obvious supra.

The objectives of the present invention is to prevent and reduce the injuries of the shoulders and upper extremities of the computer users and to reduce pain, suffering, and healthcare and business costs.

### SUMMARY OF THE INVENTION

The designs and applications of typewritter and computer keyboards of prior art do not account for the ergonomics of the upper extremity based on the anatomy, physiology and biomechanics of the shoulders and upper arms as they relate to a computer, laptop and handheld computers and the like. Consequently, unnecessary movements and poor postures of the shoulders and upper arms using said equipments of prior art resulted in the stress, strain, sprain and injuries of the structural components of the shoulders and upper arms.

The present invention is a system comprises two separate panels of computer keyboard for reducing the unnecessary motions and promoting the ergonomic posture of the hands, forearms, elbows, upper arms and shoulders of a computer-keyboard user. The system comprises a first independent keyboard panel comprises all keys bearing all numerics, alphabets, words, symbols, signs and functions to the left of and including keys 5, T, G, B. A second independent keyboard panel comprises all keys bearing all numerics, alphabets, words, symbols, signs and functions to the right of and including keys 6, Y, H, N. A camera and a support base comprises a mold for the hand-wrist-forearm and various types of sensors are incorporated into each panel to minimize the unnecessary movements and effect the ergonomic posture of the limb and shoulder.

Diagram of Preferred Embodiment

Perspective view of the present invention.

Preferred Embodiments of the Invention

A device 1 is a system of two separate and independent panels of computer keyboard to optimally maintain and promote the ergonomic postures and reducing the unnecessary motions of the shoulders and upper arms of a computer user who uses a computer, laptop computer, portable and compact computer and the like.

Said system comprises a first independent computer keyboard panel member 2 and a second independent computer keyboard panel member 3 which are being used, operated by and associated with the left upper extremity and right upper extremity of a computer user, respectively. Each panel member comprises a chassis or a supporting base 4 that is made from plastic and various man-made materials commonly used for manufacturing computer keyboards, mouses, balls, buttons, scrolling wheels and the like of prior art.

Within a first chassis 4, the left independent keyboard panel member comprises all keyboard keys universally found on computer keyboards bearing all the numerics, alphabets, words, symbols, signs and functions to the left of keys 5, T, G, B such as, but not limited to, 4, R, F, V, Esc, Cap Locks, Shift, Ctrl including keys 5, T, G, B and their specifically associated symbols and functions 6. The first chassis 4 thence said contents can be indepedently positioned, moved and maneuvered in different directions on any surface or surfaces independent of a second chassis infra. Moreover, the front end of the keyboard keys has an adjustable tilting set of keys 7 to facilitate the typing of said keys by the keying fingers. A first Return-key 8 and a first Enter-key 9 are positioned to the sides of said keyboards. It is understood that the front and back sides of said panel are defined as the side closest and farthest from the computer monitor, respectively. Therefore, first Return-key 8 or first Enter-key 9 is positioned in a plane connecting said front and back sides. In other words, using a computer keyboard of prior art, said preferred embodiment is said first Return key will be to the right of the V-key, i.e. approximately in the B-key position. Said first Enter-key will be to the left of Q-key, i.e. approximately in the Tab-key position. It is emphasized that in said first panel, the first Enter-key 8 is positioned forward of first Return-key 9 or a portion of said first Enter-key is positioned forward of said first Return-key.

Similarly, with a second chassis 5, the right independent computer keyboard panel member 3 comprises all keyboard keys bearing all the numerics, alphabets, words, symbols, signs and functions to the right of keys 6, Y, H, N universally found on computer keyboards such as, but not limited to, 7, U, J, M, Backspace, Alt, Delete including keys 6, Y, H, N and their specifically associated symbols and functions 10. In this part of the diagram, portion of the keyboard is left untilted. The second chassis 5 can be indepedently positioned, moved and maneuvered in different directions on any surface or surfaces independent of said first chassis.

A second Return-key 11 and a second Enter-key 12 are positioned to the sides of said keyboards 10. Based on above explanation, second Return-key 111 or second Enter-key 12 is positioned in a plane connecting said front and back sides. In other words, using a computer keyboard of prior art, said preferred embodiment is said second Return key will be to the left N-key, i.e. approximately in the B-key position. Said second Enter-key will be to the right of P-key, i.e. approximately in the {-key position. It is emphasized that in said second panel, the said second Enter-key is positioned forward of said second Return-key or a portion of said second Enter-key is positioned forward of said second Return-key.

In addition, each said panel member further comprises computer mouse 13, balls 14, buttons 15, wheels 16, dials, scrolling and pointing devices and a camera 17 means for monitoring and scrutinizing the movements and postures of the ipsilateral shoulder and upper arm or both shoulders and upper arms. The camera has adjustably swivelling lens or lenses adaptable to serve the function of surveillance said structures of one or both limbs and feed the information transmitted by wireless means or wired means to a computer to achieve the goal of the present invention.

Other components and features that are commonly used and applied in the manufacturing of the supports and tractions of the common computer keyboards and mouses are incooperated into said panel members. For example, each panel has a traction means for reversibly affixing said panel in a position on the surface of a workstation 18 so that the panel does not move as the computer user's arm is operating said panel. Such traction means can be a plurality of rubber, gel or hooks-loops (VELCRO) pieces which are attached and/or glued to the undersurface of said panel and surfaces of workstations. More traction force for affixing can be achieved, for example, by rubberizing a large portion of the undersurface of the panel. In addition, said components and features are applied for all the structures supra.

By its virtue alone, the left keyboard panel and the right keyboard panel of the present invention can achieved the goal of the present invention. Each keyboard panel is able to position the respective shoulder and upper arm in the ergonomic posture and to minimize, if not altogether eliminate, the frequent and unnecessary internal and external rotations, adductions, abductions, compression, impingement and combination thereof of the upper arm, shoulder and associated structures such as muscles, tendons, bursae, ligaments, muscles and bones. In other words, said panel can be independently moved and positioned by the respective hand and forearm into a position whereby a specific desirable flexion angle at the elbow between the forearm and the upper arm is achieved and maintained. Consequently, said effect results in the ergonomic posture of the ipsilateral shoulder and upper arm. The optimal condition is achieved wherein the ipsilateral hand, forearm, elbow, upper arm and shoulder are comfortably positioned and only the fingers and the muscles in the forearm are performing the typing of the keys. Thus, the goal of the present invention is achieved.

However, artificial intelligence is incorporated into the system of the present invention to compensate for human variabilites. Therefore, first, attached to or incorporated into said panel is a hand-wrist-forearm support base 19 on which a hand-wrist-forearm complex (HWFA) of an upper extremity of a computer operator using said panel can engage and rest. A preferred embodiment is said support base comprises a cast or a mold 20 of an average or typical HWFA or it can be a mold or die of varying sizes of HWFA. To help understanding the concept of the present invention, a HWFA fitting said mold functions like a stylus of and the lower and upper arm function like the arms of a phonograph or a seismograph. In other words, in practice, said support base, mold and HWFA control and effect a flexion angle between the forearm and the upper arm at the elbow. In turn, specific desirable flexion angle at the elbow controls the position of the ipsilateral shoulder and upper arm and effects an ergonomic posture of said shoulder and upper arm. Said effects become obvious infra.

Components and features that are commonly used and applied in the manufacturing of the computers, supports and furnitures are used to make said support base. Materials include various types of plastics, vinyls and other synthetics of practicality and comfort.

Second, the hand-wrist-forearm support base comprises a contact-sensor means for monitoring the positions, orientations of and contacts between the hand, wrist and forearm and the contact-sensor means 21. By said very shape of the HWFA-mold, a plurality of pressure-sensitive sensors can be strategically incorporated into the mold. Each sensor has the ability to detect and monitor a range of pressure being exerted on said support base and/or said sensor. For example, two sensors 22 can be incorporated in the hand part, two sensors can be incorporated in the wrist part (not shown) and two sensors 21 are incorporated in the forearm part of said HWFA-mold.

Furthermore, the hand-wrist-forearm support base comprises a temperature-sensor means for detecting and monitoring the positions, orientations of and contacts between the hand, wrist and forearm 23. The temperatue-sensor detects and monitor the heat emitted by the hand, wrist and forearm of said HWFA. Each sensor has the ability to detect and monitor a range of heat or lack thereof being exerted on said support base and/or said sensor. Similarly, as described supra, by said very shape of said mold, a plurality of temperature-sensitive sensors can be strategically incorporated into said mold to achieve their functions. For example, two sensors can be incorporated in the hand part, two sensors can be incorporated in the wrist part and two sensors are incorporated in the forearm part of said mold. In place of temperature sensors or incorporate with said sensors, a plurality of acoustic generating devices and acoustic detecting sensor or monitor (sonar)—not shown—can be strategically incorporated into the mold to achieve said function and purpose.

The sensitivity of each sensor member in different categories or combination of categories of sensors can be adjusted to achieve the goal of the present invention—the ergonomic and least stressed condition of the shoulder and upper arm. For example, the sensitivity of each sensor member can be tuned or adjusted to be more or less sensitive than that of othe sensor members in different location of said mold. Consequently, said HWFA is positioned in a specific attitude in said mold as demanded by said finely tuned sensors in order to comply with the computer programs collecting data from and feedbacking to and operating said sensors. As explained using the phonograph as example, the result is a desired flexion angle between the forearm and upper arm at the elbow. In turn, as described supra, specific said flexion angle controls and effects the reduction or elimination of the unneccessary motions of and the promotion or achievement of the ergonomic posture of the ipsilateral shoulder and upper arm.

Similarly, said hand-wrist-forearm support base and said sensors are able to compel said desired results. Using a specific type of said sensors or a combination of different types of said sensors, the support base can be used together with at least a computer program to compel the HWFA to be positioned, oriented and maintained in a specific desired position or ergonomic posture and attitude of the hand, wrist, forearm, upper arm and shoulder. Said sensors can operate with an on-off switch means for intelligently turning on and off the function of said panel. Furthermore, a timing device for permitting a certain period of disengagement and/or engagement of HWFA with said mold, support base and keyboard panel. In other words, a timing device is incorporated into said panel, support base and mold. Said timing device is programed to permit a certain period of disengagement of the HWFA from the panel or support base before the system informs the computer operator of the disruption of the engagement between said HWFA and said sensors. Various outcomes and actions to be taken are programmed into the computer. Two of the consequences are visually and/or auditory informing the computer operator to comply with said ergonomic requirement or, ultimately, the performance of the panel and computer is disrupted or temporarily terminated. On the other hand, said timing device also permits a certain period of engagement of said HWFA with said panel and/or support base before the system informs and permits the computer operator to take a break. Said achievements are also assisted by said camera and its softwares.

A computer software means for collecting, computing and analyzing the information and data on the movements, positions, orientations, postures and degrees of stress on the hands, wrists, arms and shoulders generated by said panels, cameras, support bases and sensors can be used to inform the operator on the positions and postures of said limbs and shoulders by visual or auditory means and combination thereof.

In laptop and portable computers—not shown in the diagram—in place of the keyboards of prior art, a housing is used to compact and store said left and right panels and support base. A retracting, swivelling and/or hinge means for positioning, moving and maneuvering in different directions said panels are used to compact and expand said panels within and beyond, respectively, the body of said computers. As described supra, a base supporting means for variably affixing a position of said panel and a traction means for adjustably affixing a position of said panel are incorporated.

Although the preferred embodiments have been described, it will be appreciated by those skilled in art that variations, adaptations, configurations and geometries of the present invention can be had without departing from the spirit of the invention and the scope of the claims.

Although the preferred embodiments have been identified and described said equipments and computers, it will be appreciated by those skilled in art that the present invention including its variations and adaptations can be used and applied to other equipments, devices and computers which were not described or identified without departing from the spirit of the invention and the scope of the claims.

1. A system of two separate panels of computer keyboard means for reducing the motions and promoting the ergonomic posture of the shoulders and upper arms of a computer-keyboard user operating a computer and a laptop computer wherein a first independent computer keyboard panel member comprising all computer keyboard keys bearing all numerics, alphabets, words, symbols, signs and functions to the left of keys 5, T, G, B universally found on computer keyboards including keys 5, T, G, B and their associated symbols and functions, a first Space-key, a first Enter-key and a first camera means for surveillance, and a second independent computer keyboard panel member comprising all keyboard keys bearing all numerics, alphabets, words, symbols, signs and functions to the right of keys 6, Y, H, N universally found on computer keyboards including keys 6, Y, H, N and their associated symbols, a second Space-key, a second Enter-key and a second camera means for surveillance, wherein said panel members comprising computer mouses, balls, buttons, wheels, dials, and scrolling and pointing devices, and wherein said panel adaptable to be indepedently positioned, moved and maneuvered in different directions on any surface or surfaces.

2. A system of two separate panels of computer keyboard means for reducing the motions and promoting the ergonomic posture of the shoulders and upper arms of a computer-keyboard user operating a computer and a laptop computer wherein a first independent computer keyboard panel member comprising all computer keyboard keys bearing all numerics, alphabets, words, symbols, signs and functions to the left of keys 5, T, G, B universally found on computer keyboards including keys 5, T, G, B and their associated symbols and functions, a first Space-key, a first Enter-key and a first camera means for surveillance, and a second independent computer keyboard panel member comprising all keyboard keys bearing all numerics, alphabets, words, symbols, signs and functions to the right of keys 6, Y, H, N universally found on computer keyboards including keys 6, Y, H, N and their associated symbols, a second Space-key, a second Enter-key and a camera means for surveillance, wherein said panel members comprising computer mouses, balls, buttons, wheels, dials, and scrolling and pointing devices, and wherein said first panel adaptable to be indepedently positioned, moved and maneuvered in different directions on any surface or surfaces comprises:
a first independent left-panel computer keyboard means for reducing the motions of the left shoulder and upper arm;
said first independent left-panel computer keyboard means for reducing the stress on the left shoulder and upper arm;
a first Return-key;
a first Enter-key;
a first camera means for scrutinizing the shoulder and upper arm with adjustably swivelling lens;
a second independent right-panel computer keyboard means for reducing the motions of the right shoulder and upper arm;
said second independent righ-panel computer keyboard means for reducing the stress on the right shoulder and upper arm;
a second Return-key;
a second Enter-key;
a second camera means for scrutinizing the shoulder and upper arm with adjustably swiveling lens;
a shoulder-arm positioning sensor means for monitoring a position of shoulder and upper arm;
a means for positioning a shoulder and upper arm;
a means for monitoring a position of a shoulder and upper arm;
a means for compelling a desired position of a shoulder and upper arm;
a means for maintaining a posture of a shoulder and upper arm;
a timing means for permitting the amount of time of disengagement of the hand, wrist and forearm from said means;
a computer software means for computing and analyzing the information and data on the movements, positions, orientations and degree of stress on the shoulder and upper arm generated by the interaction between the hand, wrist and forearm and said means;
a base supporting means for variably affixing a position of said panel; and
a traction means for adjustably affixing a position of said panel.

3. The system of two separate panels of computer keyboard means according to claim 2 wherein said first independent left-panel computer keyboard means for reducing the motions of the left shoulder and upper arm comprises a chassis supporting all computer keyboard keys bearing all numerics, alphabets, words, symbols, signs and functions to the left of keys 5, T, G, B universally found on computer keyboards including keys 5, T, G, B and their associated symbols and functions, a first Space-key and a first Enter-key to the sides of said keyboard keys, and a first camera means for surveillance, computer mouses, balls, buttons, wheels, dials, and scrolling and pointing devices.

4. The system of two separate panels of computer keyboard means according to claim 2 wherein said second independent right-panel computer keyboard means for reducing the motions of the right shoulder and upper arm comprises a chassis supporting all computer keyboard keys bearing all numerics, alphabets, words, symbols, signs and functions to the right of keys 6, Y, H and N universally found on computer keyboards including keys 6, Y, H, N and their associated symbols and functions, a second Space-key and a second Enter-key to the sides of said keyboard keys and a second camera means for surveillance, computer mouses, balls, buttons, wheels, dials, and scrolling and pointing devices.

5. The system of two separate panels of computer keyboard means according to claim 2 wherein said shoulder-arm positioning sensor means for monitoring a position of shoulder and upper arm is a plurality of cameras having swivelling lenses.

6. The system of two separate panels of computer keyboard means according to claim 2 wherein said means for positioning a shoulder and upper arm comprises a hand-wrist-forearm support means for effecting an ergonomic flexion angle at the elbow between the forearm and the upper arm and an ergonomic posture of the ipsilateral shoulder and upper arm.

7. The system of two separate panels of computer keyboard means according to claim 2 wherein said means for monitoring a position of a shoulder and upper arm comprises a hand-wrist-forearm support means for effecting an ergonomic flexion angle at the elbow between the forearm and the upper arm and an ergonomic posture of the ipsilateral shoulder and upper arm.

8. The hand-wrist-forearm support means according to claim 7 comprises a contact-sensor means for monitoring the positions, orientations of and contacts between the hand, wrist and forearm and the contact-sensor means.

9. The hand-wrist-forearm support means according to claim 7 comprises a heat-cold sensor means for detecting and monitoring the heat emitted by the hand, wrist and forearm.

10. The hand-wrist-forearm support means according to claim 7 comprises a pressure-sensor means for monitoring the pressures and forces being exerted by the hand, wrist and forearm on the pressure-sensor means.

11. The system of two separate panels of computer keyboard means according to claim 2 wherein said means for compelling a desired position of a shoulder and upper arm comprises a hand-wrist—forearm configuration supporting mold means for adjustably coupling a hand and forearm with said panel.

12. The hand-wrist-forearm configuration supporting mold means according to claim 11 comprises a contact-sensor means for monitoring the positions, orientations of and contacts between the hand, wrist and forearm and the contact-sensor means.

13. The hand-wrist-forearm configuration supporting mold means according to claim 11 comprises a temperature sensor means for detecting and monitoring the heat emitted by the hand, wrist and forearm.

14. The hand-wrist-forearm configuration supporting mold means according to claim 11 comprises a sensor for detecting and measuring a range of pressures and/or forces being exerted by the ipsilateral hand, wrist and forearm on said supporting mold means.

15. The hand-wrist-forearm configuration supporting mold means according to claim 11 comprises an on-off switch means for turning on and off the function of said panel.

16. The hand-wrist-forearm configuration supporting mold means according to claim 11 comprises a timing device for permitting a certain period of disengagement of hand, wrist and forearm from said supporting mold means.

17. The system of two separate panels of computer keyboard means according to claim 2 wherein said means for maintaining a posture of a shoulder and upper arm comprises:
a contact-sensor means for monitoring the positions, orientations of and contacts between the hand, wrist and forearm and the contact-sensor means;
a temperature sensor means for detecting and monitoring the heat emitted by the hand, wrist and forearm;
a sound generating device;
a sound detecting device;
a sensor for detecting and measuring a range of pressures and/or forces being exerted by the ipsilateral hand, wrist and forearm on said supporting mold means;
an on-off switch means for turning on and off the function of said panel;
a timing device for permitting a certain period of disengagement of hand, wrist and forearm from said supporting mold means; and
a camera means for surveillance a position of the shoulder and upper arm.

18. A system of two separate panels of computer keyboard means for reducing the motions and promoting the ergonomic posture of the shoulders and upper arms of a computer-keyboard user operating a computer and a laptop computer comprises:
a first independent panel in a first chassis comprising all computer keyboard keys bearing all numerics, alphabets, words, symbols, signs and functions to the left of keys 5, T, G, B universally found on computer keyboards including keys 5, T, G, B and their associated symbols and functions, a first Space-key, a first Enter-key and a first camera means for surveillance, computer mouse, ball, button, wheel, dial and scrolling and pointing devices;
a second independent computer keyboard panel member comprising all keyboard keys bearing all numerics, alphabets, words, symbols, signs and functions to the right of keys 6, Y, H, N universally found on computer keyboards including keys 6, Y, H, N and their associated symbols, a second Space-key, a second Enter-key and a second camera means for surveillance, computer mouse, ball, button, wheel, dial and scrolling and pointing devices.
a means for positioning a shoulder and upper arm;
a means for monitoring a position of a shoulder and upper arm;
a means for compelling a desired position of a shoulder and upper arm;
a means for maintaining a posture of a shoulder and upper arm;
a timing means for permitting the amount of time of disengagement of the hand, wrist and forearm from said means;
a camera means for surveillance a position of the shoulder and upper arm;
a computer software means for computing and analyzing the information and data on the movements, positions, orientations and degree of stress on the shoulder and upper arm generated by the interaction between the hand, wrist and forearm and said means;
a housing means for compacting and storing said panels in a computer;
a housing means for compacting and storing said panels in a laptop computer;
a housing means for compacting and storing said panels in a portable computer;
a retracting means for positioning, moving and maneuvering in different directions said panels;
a swivel means for positioning, moving and maneuvering in different directions said panels;
a hinge means for positioning, moving and maneuvering in different directions said panels;
a base supporting means for variably affixing a position of said panel; and
a traction means for adjustably affixing a position of said panel.
